(19) United States
(12) Patent Application Publication
(10) Pub. No.: US 2010/0228628 A1
(43) Pub. Date: Sep. 9, 2010

(54) Integrated Real-Time Ancillary Revenue Optimization System

(76) Inventor: Robert M. Dufour, Richmond, VA (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/397,200

(22) Filed: Mar. 3, 2009

(51) Int. Cl. G06Q 30/00

(52) U.S. Cl. 705/14.53; 705/26

(57) ABSTRACT

Systems, methods and computer program products for providing a user with a real-time ancillary offer(s) that maximize profits for merchants by increasing the likelihood of ancillary sales. Ancillary revenue sales include revenue generated from goods or services that differ from or enhance the main product or service lines of a company. An embodiment includes a ancillary revenue maximization engine and a recommendation engine. The user is provided with an ancillary offer generated by the ancillary revenue maximization engine, immediately before a merchant processes a sale with a user. In another exemplary embodiment, the user is provided with an ancillary offer generated by the ancillary revenue maximization engine after a merchant processes a sale with a user. An ancillary offer refers to an offer made to a customer by a merchant to sell an ancillary product or service. The ancillary revenue maximization engine may generate such an ancillary offer based on input received from a recommendation engine. In an embodiment, the recommendation engine uses rule selection, conversion segmentation and product selection to recommend one or more products that may enhance the value of a product or service purchased by a user and may maximize profit to the merchant processing the sale.

### BACKGROUND

1. Field of the Invention

The present invention relates generally to e-commerce, and more particularly to e-commerce ancillary revenue generation.

2. Background Art

The growth of online merchants has led to a substantial increase in e-commerce over the past decade. In addition to online merchants, traditional stores and outlets operated by merchants are increasingly adopting the Internet as a means to process sales of products or services. Consumers are being offered a variety of methods to browse, select and purchase products using different payment methods through the Internet and point of sale terminals.

Cross-sell is a broad marketing term for the practice of suggesting related products or services to a customer who is considering buying something. A primary or main product or service is a product or service which a consumer is intending to purchase and for which they enter a web site. Such a primary product or service includes the mainline product or service of the company (e.g. books at Amazon). If a person is buying a book on Amazon.com, for example, that person may be shown a list of books similar to the one the person has chosen or books purchased by other customers that bought the same book as the person. In another example, a search on a company's Web site for bed linens might also bring up listings of matching draperies. The most ubiquitous example of cross-sell is likely the oft-spoken fast food phrase: “Would you like fries with that?” Cross-selling may include some specific sub-categories such as pre-sale, up-sell and post-sale or ancillary revenue sales.

Pre-sale offers refer to offers that are made prior to the sale of a product or service. Pre-sale offers often include providing users options of purchasing additional products or services similar in some respects to a consumers potential purchase. For example, a merchant may advertise images or descriptions of products which might be at a discounted price or which have been previously bought along with the product a customer is purchasing. Up-selling involves suggesting more expensive items to a customer making a purchase.

Post-sale or ancillary revenue sales includes revenue generated from goods or services that differ from or enhance the main product or service lines of a company. Ancillary revenue can vary from a car wash at a fuel station to ads on airlines. In some cases, what began as an ancillary revenue source can become the main source of revenue for a company (e.g. travel insurance for low cost airlines). Ancillary revenue can be generated from direct sales to consumers or indirectly as part of the total purchase experience. Ancillary revenue can be generated through margin (if the offering company owns the ancillary revenue products such as airlines offering extra baggage costs) or through a commission or marketing fee when selling third party goods. Additionally, several companies realize the bulk of their product sales margin through use of post-sale products. The Internet and the ability to compare product prices, helps keep online margins low. The use of post-sale products as an impulse buy allows the merchant to greatly improve overall margins on online purchases.

Merchants have been offering customers a variety of pre-sale offers. Pre-sale offers may not be usually effective as they may not enhance the value of a product or service being purchased by a customer and may actually distract the customer before a purchase is completed. Furthermore, such pre-sale offers may be based on a static database of purchase history without much consideration for individual characteristics of a person purchasing a product. Thus a need exists to offer a consumer a product or service, after a sale has been completed, that not only enhances the value of a consumer's purchase but also increases the likelihood of sale of such a product or service.

Therefore, what is needed is an integrated and real-time system that generates an ancillary offer, in a manner that maximizes profits for merchants making such offers.

### BRIEF SUMMARY

Briefly stated the invention includes a system, method, computer program product and combinations and sub-combinations thereof for providing a user with a real-time ancillary offer(s) that maximize profits for merchants by increasing the likelihood of ancillary sales. Ancillary revenue sales includes revenue generated from goods or services that differ from or enhance the main product or service lines of a company. An embodiment includes, an ancillary revenue maximization engine and a recommendation engine. The user is provided with an ancillary offer generated by the ancillary revenue maximization engine, immediately before a merchant processes a sale with a user. In another exemplary embodiment, the user is provided with an ancillary offer generated by the ancillary revenue maximization engine after a merchant processes a sale with a user. An ancillary offer refers to an offer made to a customer by a merchant to sell an ancillary product or service. Furthermore ancillary offer may refer to multiple offers (e.g., extended warranty and credit) either as a concatenated offer or as a bundled offer. The ancillary revenue maximization engine may generate such a ancillary offer based on input received from a recommendation engine. In an embodiment, the recommendation engine uses rule selection, conversion segmentation and product selection to recommend one or more products that may enhance the value of a product or service purchased by a user and may increase the probability of sale of the ancillary product or service.

In an embodiment, the ancillary revenue maximization engine receives data from the merchant just before a user completes a purchase and before a confirmation or a ‘thank-you’ page is displayed to the user. Thus, the ancillary revenue maximization engine generates ancillary offer(s) in real-time without any separate input from the user. Furthermore, generation of ancillary offer(s) is integrated into the purchase and sale confirmation process.

In this way, a merchant may generate ancillary offers that enhance the value of a product or service purchased by a user, while also increasing the probability of sale of the ancillary product or service.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 is an architecture diagram of a system for integrated real-time ancillary revenue optimization according to an embodiment of the invention.

FIG. 2 is a flowchart illustrating an exemplary pre-sale user-merchant interaction according to an embodiment of the invention.

FIG. 3 is a flowchart illustrating a merchant providing data to ancillary revenue maximization engine, according to an embodiment of the invention.

FIG. 4 is an architecture diagram illustrating exemplary databases that may be associated with a ancillary revenue maximization engine according to an embodiment of the invention.

FIG. 5 is a diagram illustrating the exemplary operating modes of the ancillary revenue maximization engine, according to an embodiment of the invention.

FIG. 6 is an architecture diagram illustrating exemplary databases that may be associated with a recommendation engine according embodiment of the to an invention.

FIG. 7 illustrates processing of a ancillary offer by a merchant according to an embodiment of the invention.

FIG. 8 illustrates processing of payment for an ancillary product or service according to an embodiment of the invention.

FIG. 9 is a flowchart illustrating processing of commission to be paid to a supplier of an ancillary product or service, according to an embodiment of the invention.

FIG. 10 illustrates an example computer useful for implementing components of the invention.

The features and advantages of the present invention will become more apparent from the detailed description set forth below when taken in conjunction with the drawings. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION

The present invention relates to generating real-time ancillary offer(s) that enhance the value of a product or service purchased by a user from a merchant. As used herein, “cross-sell” is a broad marketing term for the practice of suggesting related products or services to a customer who is considering buying something. Cross-selling may be further divided into specific sub-categories. These include pre-sale, up-sell and post-sale or ancillary revenue sales. As used herein, pre-sale offers refer to offers that are made prior to the sale of a product or service. Up-selling involves suggesting more expensive items to a customer making a purchase. Post-sale or ancillary revenue sales include revenue generated from goods or services that differ from or enhance the main product or service lines of a company. As an example, ancillary revenue can vary from a car wash at a fuel station to ads on airlines. In some cases, what began as an ancillary revenue source can become the main source of revenue for a company such as travel insurance for low cost airlines. Ancillary revenue can be generated from direct sales to consumers or indirectly as part of the total purchase experience. Ancillary revenue can be generated through margin (if the offering company owns the ancillary revenue products such as airlines offering extra baggage costs) or through a commission or marketing fee when selling third party goods. The term “ancillary offer” used herein refers to an offer made to a customer by a merchant to sell an ancillary product or service.

An ancillary revenue maximization engine generates an ancillary offer based on input received from a recommendation engine. In addition to enhancing the value of a product or service purchased by a user, such an ancillary offer has a higher likelihood of being accepted by a user, thereby increasing profit for a merchant. As an example, not intended to limit the invention, an offer that is not easy to purchase and is not personalized may be able to generate a 1% sales rate. An offer that is easy to complete (e.g. by selecting a “Yes” button) can be seen to lift conversion rates, for example, by a factor of 5× or 5%. However, an offer that is personalized and easy to complete can be seen to generate 10% or more conversions to sale. In this way, pair ease of purchase and real-time personalization are used herein to maximize the likelihood of purchase of a high-margin product.

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

This detailed description of embodiments of the present invention is organized into several sections as shown by the following table of contents.

### Table of Contents

1. System
2. Pre-Sale User Merchant Interaction
3. Generation of Ancillary Offers

3.1 Ancillary Revenue Maximization Engine
3.1.1 Ancillary Revenue Maximization Engine Databases
3.1.2 Operating Modes of Ancillary Revenue Maximization Engine

3.2 Recommendation Engine
3.2.1 Data Input Phase
3.2.2 Data Validation Phase
3.2.3 Rule Selection
   3.2.3.1 Learning Mode of Recommendation Engine
3.2.4 Conversion Segmentation
3.2.5 Product Selection and Pricing
3.2.6 Message Creation
3.2.7 Offer Medium Selection
3.2.8 Offer Presentation
3.2.9 Providing Offer Selection Options
3.2.10 Saving Ancillary Offers and Optimization
3.2.11 Recommendation Engine Databases
4. User—Merchant Interaction After Ancillary Offer is Made
5. Processing of Payment for Ancillary Product or Service
6. Calculation of Commission to Ancillary Supplier
7. Example Computer Embodiment
8. Conclusion

### 1. System

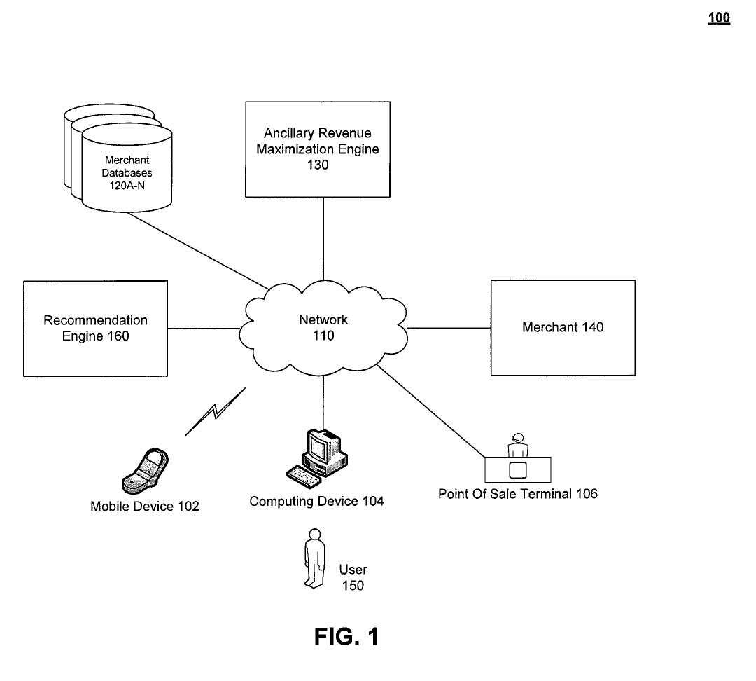

This section describes a general system architecture for generating real-time ancillary offers based on a ancillary revenue maximization engine and a recommendation engine according to an embodiment of the invention, as illustrated in FIG. 1. Note that while several servers and services are illustrated separately in FIG. 1, some can be combined in alternative embodiments of the invention. Ancillary revenue maximization engine 130 and recommendation engine 160 may be implemented on the same machine, for example. Other entities in FIG. 1 may likewise be consolidated.

System 100 includes network 110, merchant 140, merchant databases 120A-N, ancillary revenue maximization engine 130 and recommendation engine 160. Additionally, user 150 may access network 110 through point of sale terminal 106, computer 104 or mobile device 102.

Network 110 may include one or more interconnected networks, including but not limited to, a public switched telephone network, local area network, medium-area network, and/or wide-area network, such as, the Internet.

User 150 may be a potential consumer of a product of service being offered by merchant 140. User 150 may communicate with merchant 140 through mobile device 102, computer 104 or point of sale terminal 106.

Merchant 140 may be any form of online merchant or a brick-and-mortar merchant who operates a store at a geographical location. Merchant 140 may be a national or an international merchant. In an embodiment, merchant 140 receives input from a user 150 through mobile device 102, computer 104 or point of sale terminal 106 connected to network 110. An input received by merchant 140 from user 150 may correspond to an instruction to browse or purchase a product or a service. In an embodiment, merchant 140 generates ancillary offers using ancillary revenue maximization engine 130 and recommendation engine 160. On a real time basis the merchant 140 sends over information associated with a consumer purchase. This information includes the items(s) purchased, purchase dates, etc. In addition, merchant 140 may send over additional information on the purchaser. Additionally, some of this information may also be stored on a database of ancillary revenue maximization engine 130.

Merchant databases 120A-N may include information related to user 150 or any other user that may access merchant 140. Information related to user 150 may include, but is not limited to, an account username, password, preferences, past sale histories, user profile data which may further include age, location and other similar details. It should be understood that merchant databases 120A-N are shown for illustrative purposes and in any embodiment, merchant 140 may have access to other databases used by ancillary revenue maximization engine 130 and recommendation engine 160. Exemplary databases used by ancillary revenue maximization engine 130 and recommendation engine 160 are described further below.

Ancillary revenue maximization engine 130 interrogates merchant information (e.g. segments, etc.) and then subjects it to existing business rules algorithms (i.e., for a stated merchant product purchased then offer this ancillary product at this given price with a particular message with a certain kind of merchandising displays with this type of graphical display.) Additionally, the manner in which purchasing is to be made is also included in the business rule (e.g. an opt-in or positive option). The offer is “woven together from it's component pieces and sent back to merchant 140 on a real-time basis. In an embodiment, the goal of the offer sent is to maximize the revenue per offer for the ancillary offer.

Ancillary revenue maximization engine 130, for example, can be implemented as a learning engine. In an embodiment, ancillary revenue maximization engine 130 is a campaign management system. Such a campaign management system allows a user to offer tests of the various offer components (product, price, message, graphics, template, opt-in, etc.), and randomly insert the test offers against the control (best existing offer) for a particular segment. If the test offer out-performs the control offer at a statistically significant level, then the test offer will be promoted to the new control offer within the business rules. In this way, recommendation engine 160 is a business rules engine holding both control and test offers to be assigned based on some algorithm (test offer is provided to x % of incoming transactions for a given segment).

Ancillary revenue maximization engine 130, as a campaign management system, allows the testing of various offers against a control and allows for reporting/dashboard, weighting, etc. In another embodiment, such a campaign manager may be able to learn and test on it's own. Furthermore, ancillary revenue maximization engine 130 could be made up of a real-time evaluation system that generates any number of possible offers (using unique combinations of products, prices, messages, etc.) that are evaluated using a financial model on a real-time basis with the outcome being a revenue per offer estimate for each of the offer options and the engine then selects the one offer model that best optimizes revenue per offer. Offers may also be evaluated from the ancillary revenue maximization engine 130 (e.g. a campaign manager) based on test and control and then loaded into the recommendation engine 160 which is a business rules engine.

### 2. Pre-Sale User Merchant Interaction

This section describes exemplary interaction between user 150 and merchant 140, prior to purchase of a product, according to an embodiment of the invention.

In an embodiment, user 150 may communicate with merchant 140 using for example, point of sale terminal 106, computer 104 or mobile device 102. When merchant 140 is an online merchant for example, user 150 may access an online store operated by merchant 140 through a web site or similar content delivery mechanism.

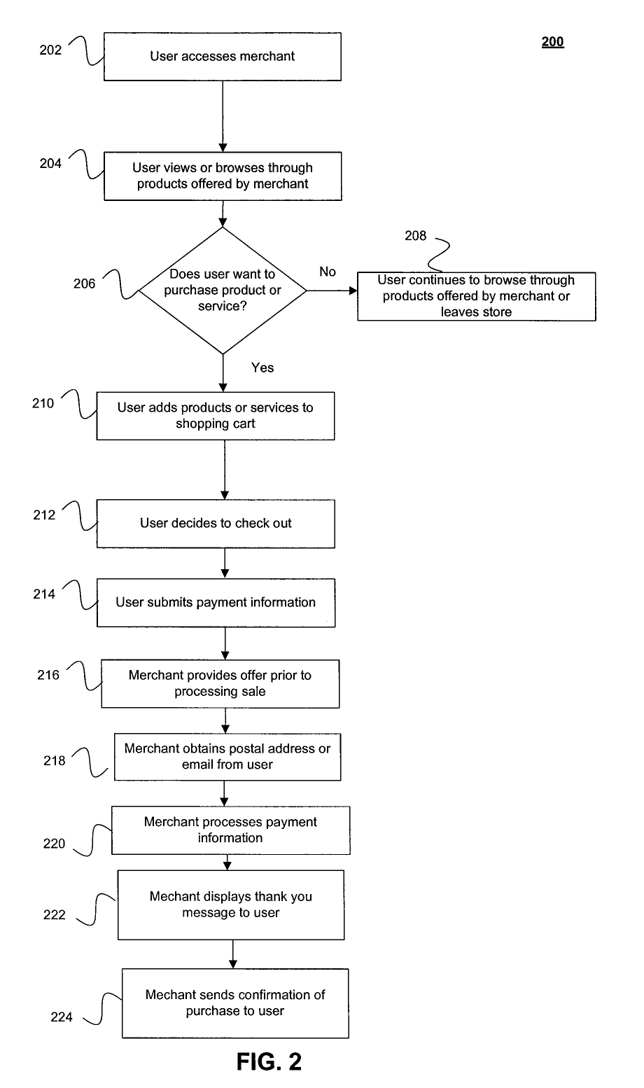

Exemplary pre-sale user merchant interaction, according to an embodiment of the invention, will now be described in detail with reference to flowchart 200 in FIG. 2.

In step 202, user 150 accesses a web-site associated with merchant 140. For example, user 150 may access a web-site through mobile device 102 or computer 104.

In step 204, user 150 may view or browse through different products or services being offered by merchant 140 through the web site.

In step 206, if user 150 decides to buy a product or service, method 200 proceeds to step 210. If user 150 does not decide to buy a product or service, method 200 proceeds to step 208.

In step 208, user 150 may leave a store operated by merchant 140 or navigate away from a website associated with merchant 140. Optionally, user may continue browsing through other products or services offered by merchant 140.

In step 210, user 150 may add products or services offered by merchant 140 to a shopping cart.

In step 212, user 150 decides to checkout. User 150 may checkout using a ‘Checkout’ button or similar user interaction element that may be provided by merchant 140 on a website. Alternatively, user 150 may check-out using point-of-sale terminal 106 operated by merchant 140.

In step 214, user 150 submits payment information to merchant 140. Payment information may be submitted using a variety of payment vehicles, including but not limited to, credit card or check.

In step 216, user 150 is provided with an ancillary offer generated by ancillary revenue maximization engine 130, immediately before merchant 140 processes a sale with the user. The operation of the ancillary revenue maximization engine is described further in the description.

In step 218, merchant obtains a postal or email address from user 150 and any other form of information associated with user 150.

In step 220, merchant 140 processes payment information submitted by user 150 in step 210 and a sale is completed.

In step 222, merchant 140 displays a thank you message to user 150 thanking the user for the purchase of a product or service. Additionally, merchant 140 may call or mail user 150 thanking user 150 for the purchase.

In step 224, merchant 140 sends an email confirmation of purchase, or a confirmation via mail providing evidence of a purchase. Additionally, merchant 140 may also include any physical product and/or instructions for use of the product.

In this way, user 150 may interact with merchant 140 and a sale of a product or service may be completed by merchant 140. Although flowchart 200 illustrates interaction where merchant 140 is an online merchant, it should be understood that pre-sale user merchant interaction illustrated by method 200 may be used by brick-and mortar merchants operating point of sale terminals at geographical locations or any other form of sale processing mechanism.

### 3. Generation of Ancillary Offers

This section describes generation of ancillary offers by ancillary revenue maximization engine 130 according to an embodiment of the invention. An ancillary offer refers to an offer made to a customer by a merchant to sell an ancillary product or service. As described earlier, ancillary revenue sales include revenue generated from goods or services that differ from or enhance the main product or service lines of a company. As an example, ancillary revenue can vary from a car wash at a fuel station to ads on airlines. In some cases, what began as an ancillary revenue source can become the main source of revenue for a company such as travel insurance for low cost airlines. Ancillary revenue can be generated from direct sales to consumers or indirectly as part of the total purchase experience. Ancillary revenue can be generated through margin (if the offering company owns the ancillary revenue products such as airlines offering extra baggage costs) or through a commission or marketing fee when selling third party goods.

Ancillary offers may be provided to user 150 by merchant 140 after completion of a purchase by user 150 as illustrated by method 200 in FIG. 2. In an example where merchant 140 is an online merchant, such an offer for sale of a ancillary product or service may be displayed on an order completion, order confirmation or a ‘thank-you’ page displayed to user 150.

3.1 Ancillary Revenue Maximization Engine

After a sale is completed by merchant 140 using a payment vehicle selected by a user 150, merchant 140 provides user 150 with an ancillary offer to sell a product or service that may enhance the value of the product or service purchased by user 150. An ancillary offer refers to an offer made to a customer by a merchant to sell an ancillary product or service. Such an offer may be generated by ancillary revenue maximization engine 130. As described earlier, the user is provided with an ancillary offer generated by the ancillary revenue maximization engine 130, immediately before a merchant processes a sale with a user. In another exemplary embodiment, the user is provided with an ancillary offer generated by the ancillary revenue maximization engine after a merchant processes a sale with a user.

Ancillary revenue maximization engine 130 may receive data from merchant 140 just before a user completes a purchase and before a confirmation or a ‘thank-you’ page is displayed to user 150. Thus ancillary revenue maximization engine 130 generates ancillary offers in real-time without any separate input from user 150. Furthermore, generation of ancillary offers is integrated into the purchase and sale confirmation process.

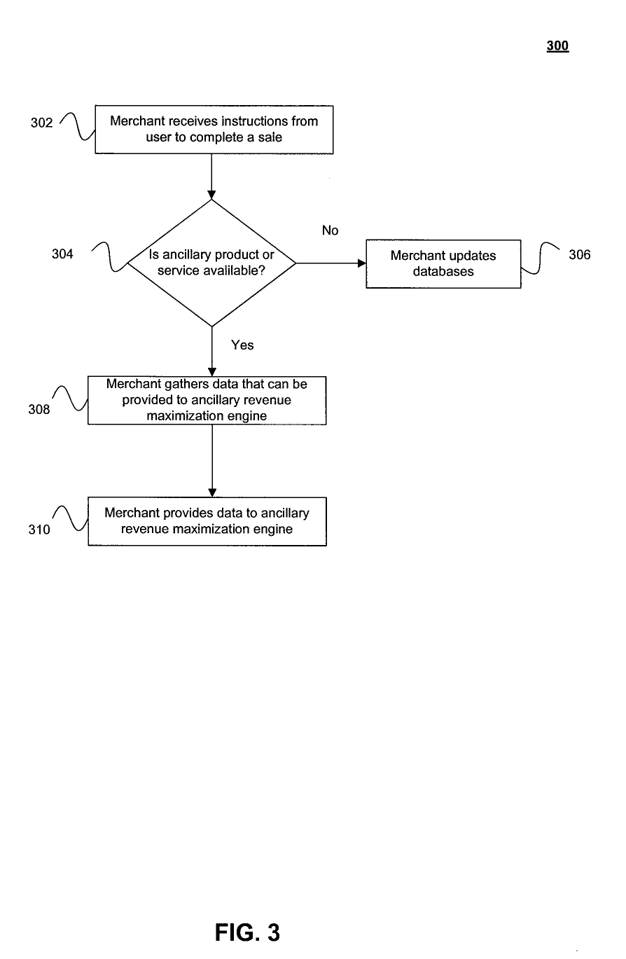

Exemplary real-time ancillary offer processing using ancillary revenue maximization engine 130 will now be described in detail with reference to flowchart 300 in FIG. 3.

In step 302, merchant 140 receives instructions from user 150 to complete a sale. For example, user 150 may provide payment though a payment vehicle and instruct merchant 140 to complete a sale.

In step 304, merchant 140 checks if an ancillary product or service is available. If a ancillary product is unavailable step 306 is performed. If an ancillary product is available steps 308 and 310 are performed.

In step 306, merchant 140 updates merchant databases 120A-N based on information received from user 150.

In step 308, merchant gathers data that can be provided to ancillary revenue maximization engine 130. Such data may include information such as the payment vehicle used by user 150, profile information of user 150 and universal product code (UPC) of the purchased product or service.

In step 310, merchant 140 provides data gathered in step 308 to ancillary revenue maximization engine 130.

In this way ancillary revenue maximization engine receives information from merchant 140.

After ancillary revenue maximization engine 130 receives information from merchant 140, the data received from merchant 140 is processed and an offer for a ancillary product or service is generated using an input from recommendation engine 160. In an embodiment, ancillary revenue maximization engine 130 may also use data from associated databases to generate a ancillary offer.

3.1.1 Ancillary Revenue Maximization Engine Databases

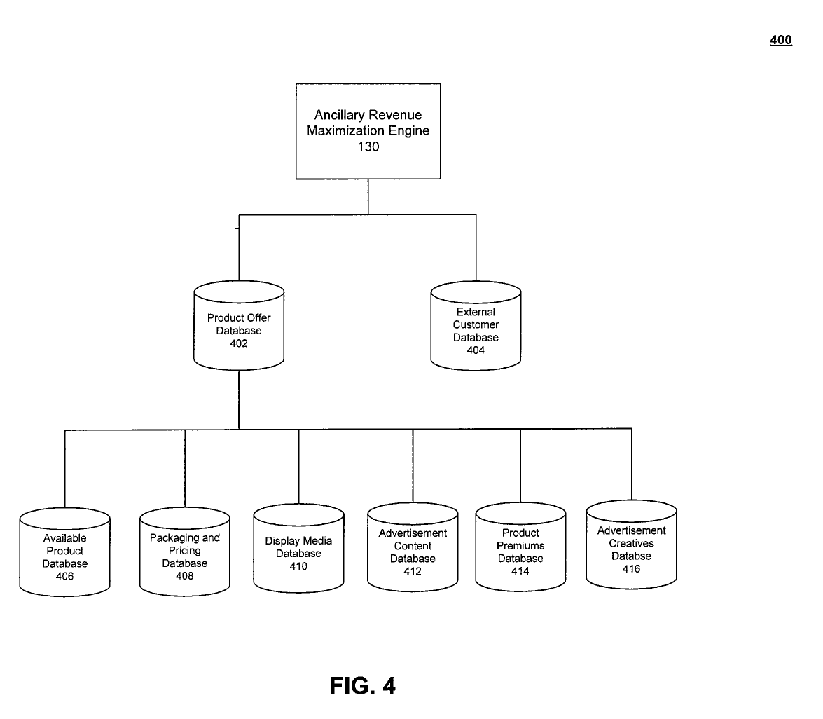

FIG. 4 illustrates various exemplary databases that may be associated with ancillary revenue maximization engine 130.

Ancillary revenue maximization engine 130 may have access to product offer database 402 and external customer database 404.

Product offer database 402 may further include an available product database 406, packing and pricing database 408, display media database 410, advertisement content database 412, product premium database 414, and/or advertisement creatives database 416.

Available product database 406 may, for example, include a database of ancillary products available to merchant 140. Such products may be supplied by merchant 140 or any other merchant who may have an agreement with merchant 140.

Packaging and pricing database 408 may include details of packaging options and pricing options available to merchant 140. Ancillary revenue maximization engine 130 may select a packaging, a pricing option and discounts to maximize the likelihood of sale of a ancillary product or service in a manner that maximizes profit for merchant 140.

Display media database 410 may include different types of display options available to merchant 140. As an example, display media options may include various forms of electronic displays. Display media options may also include graphical content (use of images and icons), daughter windows displaying additional information, color schemes and bold text, and the manner in which the selection is denoted (e.g. check boxes or radio buttons inclusive of opt-in, forced choice, opt-out, positive option, etc.)

Advertisement content database 412 includes content that may be used by merchant 140 to advertise a ancillary product or service. Advertising content may include, but is not limited to, images, audio and other forms of multimedia that may be associated with an electronic advertisement.

Product premium database 414 may include details of premiums (e.g. additional items included to enhance the sale—two for the price of one, etc.) associated with a ancillary product or service that is offered by merchant 140. In an embodiment, ancillary revenue maximization engine 130 uses product premium database 414 to select a ancillary product or service from available product database 406 in a manner that maximizes profits for merchant 140.

Advertisement creatives database 416 may include forms of content to that may enhance appeal of a ancillary product or service offered by merchant 140. For example, advertisement creatives database 416 may include advertisement templates that may be customized based on a given user profile.

Such exemplary databases may be used by ancillary revenue maximization engine 130 to generate an offer for an ancillary product or service.

3.1.2 Operating Modes of Ancillary Revenue Maximization Engine

In an embodiment, ancillary revenue maximization engine 130 may operate in a testing mode. In the testing mode, a defined sample of offers are gated randomly to a simultaneous test offer(s) and the remainder are sent to a control offer. Therefore, the test and the control to run at the same time. In this way, the test comparisons are not invalidated due to temporal effects (running the test on a Sunday and the control on a Monday). According to an embodiment, not intended to limit the invention, ancillary revenue maximization engine 130 primarily operates in the testing mode.

When ancillary revenue maximization engine 130 is in a learning mode it may modify internal business rules to optimize ancillary offers being presented to user 150. The learning mode of recommendation engine 160 will be described in greater detail further in the description.

Additionally, ancillary revenue maximization engine 130 may be in a validation mode where, in an embodiment, it serves static offers and no tests are running.

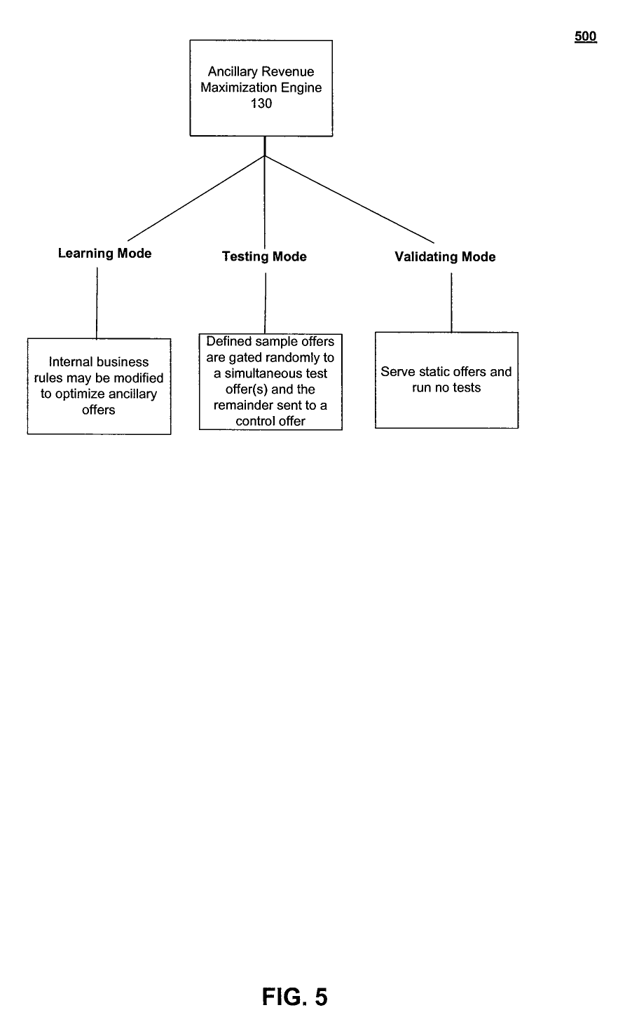

FIG. 5 illustrates the different operating modes of ancillary revenue maximization engine 130.

As illustrated in FIG. 5, when ancillary revenue maximization engine is in testing mode, a defined sample of offers are gated randomly to a simultaneous test offer(s) and the remainder are sent to a control offer. This allows the test and the control to run at the same time. When ancillary revenue maximization engine 130 may be in a validation mode where, in an embodiment, it serves static offers and no tests are running. In the learning mode, ancillary revenue maximization engine 130 may modify internal business rules to optimize ancillary offers being presented to user 150.

The ancillary revenue maximization engine receives data from the merchant just before a user completes a purchase and before a confirmation or a ‘thank-you’ page is displayed to the user. Thus, the ancillary revenue maximization engine generates ancillary offer(s) in real-time without any separate input from the user. Furthermore, generation of ancillary offer(s) is integrated into the purchase and sale confirmation process.

Also, the testing phase of ancillary revenue maximization engine 130 allows recommendation engine 160 to modify and optimize business rules associated with a product or offer for service. Recommendation engine 160 is discussed in detail in the next section.

3.2 Recommendation Engine

In an embodiment, recommendation engine 160 generates a recommendation for an offer for a ancillary product or service. Recommendation engine 160 may provide such a recommendation to ancillary revenue maximization engine 130.

The generation of a recommendation by recommendation engine 130 may be broadly classified into several separate phases as follows:

a. Data Input

b. Data Validation

c. Rule Selection

d. Conversion Segmentation

e. Product Selection and Pricing

f. Message Creation

g. Offer Medium Selection

h. Offer Presentation

i. Providing Offer Selection Options

j. Saving Ancillary Offers and Optimization

3.2.1. Data Input Phase

In an exemplary, data input phase, recommendation engine 160 receives data provided by ancillary revenue maximization engine 130 as illustrated by method 500 in FIG. 5. In an example where merchant 140 is an online merchant, data from user 150 may be received through a web-services framework on a website associated with merchant 140. Data received by merchant 140 may then be provided as an input to ancillary revenue maximization engine 130.

3.2.2. Data Validation Phase

In an exemplary data validation phase, recommendation engine 160 validates data received from ancillary revenue maximization engine 130. In an example, recommendation engine may check if values received lie in a specified range. Data validation may prevent unsolicited automated programs from making repeated attempts to extract suitable ancillary offers from merchant 140.

3.2.3 Rule Selection

In an exemplary rule selection phase, recommendation engine 160 selects a one or more business rule sets that may be used to generate a recommendation for a ancillary product or service. In an embodiment, selection of one or more business rules may be based on user 150 and product or service that has been purchased by user 150. For example, rules may be based on a user's location, gender, age etc. Rules may also be based on a time of year. For example, user 150 may be offered winter wear during winter after purchase of another product or service

Table I illustrates a illustrates a set of exemplary business rules for offering a ancillary warranty to user 150 based on a purchased product such as a flat screen TV, refrigerator or MP3 player. Such a set of business rules may be set based on market research carried out by merchant 140. Referring to Table I, a 1 year warranty for a flat screen TV may be offered for $10, a 2 year warranty for $20 and a 3 year warranty for $50. These values may be based upon statistical data gathered by merchant 140 during a marketing campaign.

TABLE I

| | 1 Year Warranty | 2 Year Warranty | 3 Year Warranty |
|---|---|---|---|
| | ($) | ($) | ($) |
| Flat screen TV | 10 | 20 | 50 |
| Refrigerator | 25 | 50 | 15 |
| MP3 Player | 90 | 85 | 75 |

3.2.3.1 Learning Mode of Recommendation Engine

In an embodiment, recommendation engine 160 may be in a learning mode. In the learning mode, recommendation engine 160 uses saved ancillary offers and results to modify its existing business rule set(s). For example, recommendation engine 160 modifies its decision methods by dynamically altering business rules to optimize ancillary purchases.

During the learning mode, ancillary revenue maximization engine 130 offers a group of products or service associated with the item purchased. Such products or services may be predefined, such as by a marketing committee and may change for different marketing campaigns. It records what ancillary products or services are purchased and updates one or more business rules. For example, business rules illustrated in Table I may be updated. Later recommendation engine 160 may use these business rules to provide a recommendation to ancillary revenue maximization engine 130.

In an embodiment, business rule sets are dynamic and are altered based on results of ancillary offers. Recommendation engine 160 may modify and optimize business rule sets when it is in a learning mode. Selection of optimized business rules enables recommendation engine 160 to make a recommendation that will increase likelihood of sale of a ancillary product or service and maximize profit for merchant 140.

3.2.4 Conversion Segmentation

In an exemplary conversion segmentation phase, recommendation engine 160 may classify user 150 into a segment that may be based on at least the product purchased and a profile of user 150 that may include age, gender and address of user 150. Classification of user 150 into a segment may determine product selection and pricing.

User 150 may be classified based on at least a user profile that may be provided to merchant 140. Such a user profile may include data such as age, product preferences, packaging preferences and the like.

User classification through conversion segmentation may be dynamically accomplished by recommendation engine 160 based on response of user 150 to a ancillary offer. Such a form of dynamic conversion segmentation may allow recommendation engine to optimize offers provided to user 150.

3.2.5 Product Selection and Pricing

In an exemplary product selection and pricing phase, recommendation engine 160 may identify a ancillary product or service and determine a price for the offered product or service based on conversion segmentation as described earlier.

In an embodiment, a product may be identified from product offer database 502. Product selection and pricing may be dynamically adjusted by recommendation engine 160 to maximize the profit to merchant 140.

3.2.6 Message Creation

In an exemplary message creation phase, recommendation engine 160 generates a message that may be associated with the ancillary product or service. As described earlier, ancillary revenue sales include revenue generated from goods or services that differ from or enhance the main product or service lines of a company. As an example, ancillary revenue can vary from a car wash at a fuel station to ads on airlines. In an embodiment, such messages are dynamically generated and include a headline, and introduction, a body, promotional line, a header and footer. Recommendation engine 160 may thus generate a message in a form that is specific to user 150 or a product that has been purchased by user 150. In the exemplary case where merchant 140 is an online merchant, messages generated by recommendation engine 160 may be placed on a sale confirmation or a ‘thank-you’ page after a sale has been completed by merchant 140.

3.2.7 Offer Medium Selection

In an embodiment, recommendation engine 160 identifies a medium by which a ancillary offer is to be presented to user 150. Recommendation engine may analyze the characteristics of user 150 using merchant databases 120A-N or by external customer database 504. Recommendation engine 160 may then identify a medium to present a ancillary offer to user 150. As an example, recommendation engine 160 may present the offer electronically (e.g. website) or through a human (e.g. a telephone call to user 150). Additionally recommendation engine 160 may decide if graphics are to be displayed along with a textual offer.

3.2.8 Offer Presentation

In an embodiment, recommendation engine 160 may also determine offer presentation. As an example, offer presentation may include, image, text or multimedia associated with a ancillary product, ancillary product price, ancillary offer medium and offer message into a single offer that has the highest likelihood to be accepted by user 150. Acceptance of a ancillary offer by user 150 may increase profit to merchant 140.

3.2.9 Providing Offer Selection Options

In an embodiment, recommendation engine 160 may decide offer selection options. In the exemplary case where merchant 140 is an online merchant recommendation engine 160 may identify and recommend an offer selection option. An offer selection option, for example, may include, radio buttons, check boxes, a positive option basis, an opt-out option basis, an opt-in option basis or an option to select a combination of ancillary offers.

3.2.10 Saving Ancillary Offers and Optimization

After recommendation engine 160 provides a recommendation to ancillary revenue maximization engine 130, the offer is presented to user 150 by merchant 140. User 150 may accept or decline the offer. In either case, recommendation engine 160 may save all ancillary offers made and the result of such offers along with the offer medium used, pricing, selection options and graphics.

In another embodiment, recommendation engine 160 may be in a learning mode. In the learning mode, recommendation engine 160 uses saved ancillary offers and results to modify its existing business rule set. For example, recommendation engine 160 modifies its decision methods by dynamically altering business rules to optimize ancillary purchases.

In this way, merchant 140 may generate ancillary offers that enhance the value of a product or service purchased by user 150 while maximizing profits for merchant 140. Although the above phases are listed sequentially, it is to be understood that they need not be carried out in any particular order. Different phases may occur concurrently or may be combined in a single phase. For example, rule selection and conversion segmentation may be carried out in one phase. This example is illustrative and not intended to limit the invention.

3.2.11 Recommendation Engine Databases

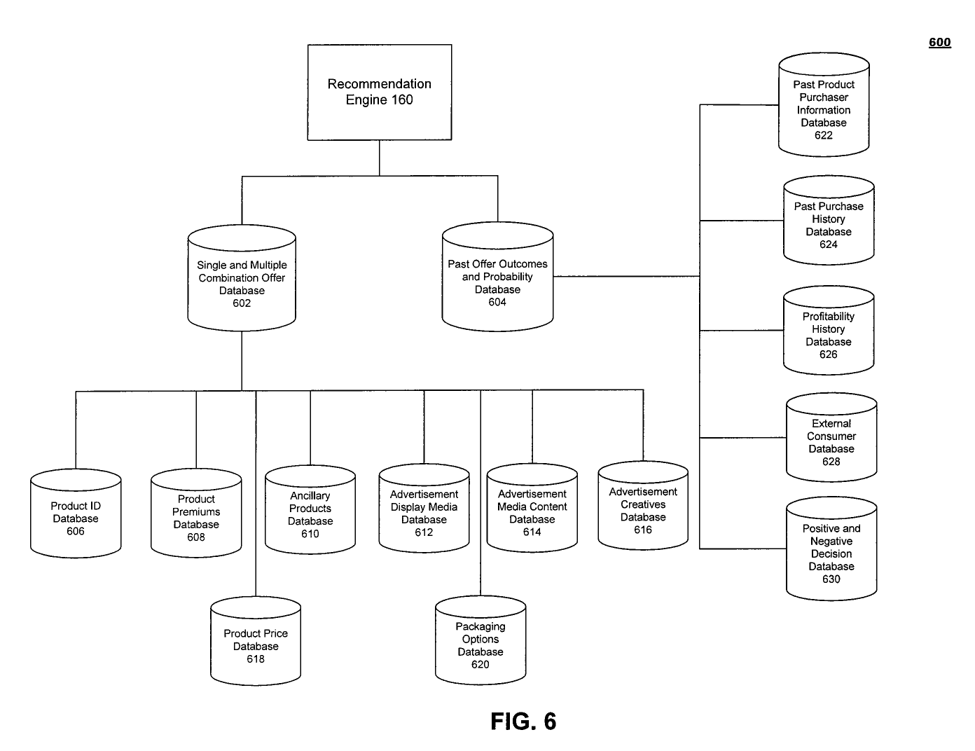

FIG. 6 illustrates various exemplary databases that may be associated with recommendation engine 160.

Recommendation engine 160 may have access to single and multiple combination offers database 602 and past offer outcomes and probability database 604.

Single and multiple combination offers database 602 may have access to product ID database 606, product premiums database 608, ancillary products database 610, advertisement display media database 612, advertisement media content database 614, advertisement creatives database 616, product price database 618, packaging options database 620.

Past offer outcomes and probability database 604 may have access to past product purchaser information database 622, past purchase history database 624, profitability history database 626, external consumer database 628, positive and negative decision database 630.

Recommendation engine 160 may use information in these databases to generate a recommendation that can be provided to ancillary revenue maximization engine 130. In an embodiment, these databases are updated by merchant 140.

### 4. User—Merchant Interaction After Ancillary Offer is Made

In an embodiment, after recommendation engine 160 generates a recommendation to ancillary revenue maximization engine 130, merchant 140 provides an ancillary offer to user 150. An ancillary offer refers to an offer made to a customer by a merchant to sell an ancillary product or service. As described earlier, ancillary revenue sales include revenue generated from goods or services that differ from or enhance the main product or service lines of a company. As an example, ancillary revenue can vary from a car wash at a fuel station to ads on airlines.

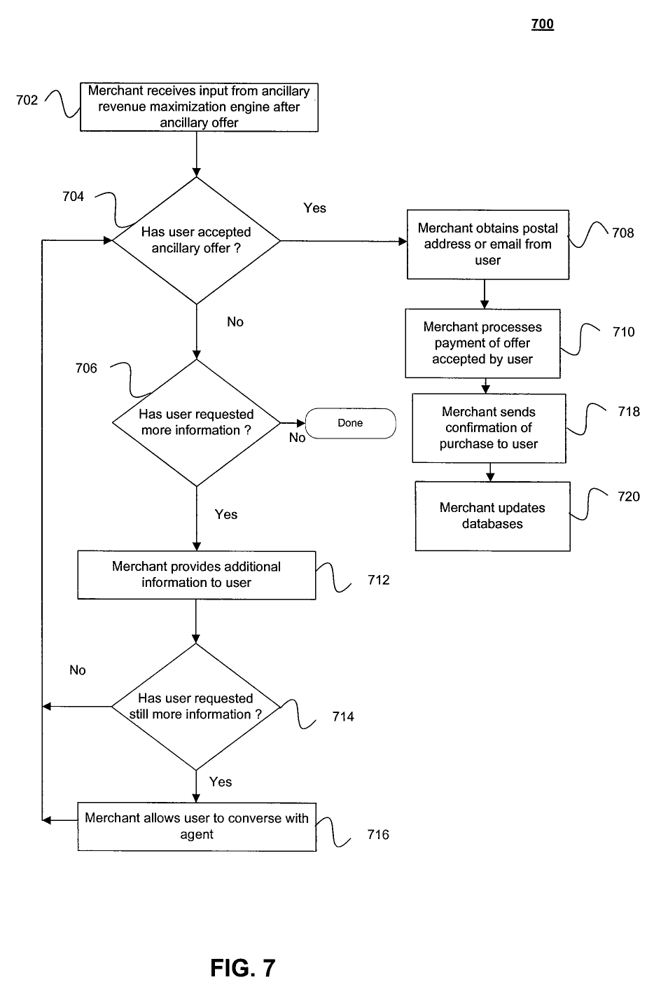

Exemplary interaction between merchant 140 and ancillary revenue maximization engine 130, after an ancillary offer is made, will now be described in detail with reference to flowchart 700 in FIG. 7.

In step 702, merchant 140 receives an input from user 150 after a ancillary offer has been made. Such an input may be received either through a button on a web page or though mail or telephone or any other medium that has been used to present the offer.

In step 704, merchant 140 checks if user 150 has accepted the ancillary offer. If user 150 has not accepted the ancillary offer, step 706 is performed. If a user has accepted the ancillary offer steps 708 and 710 are performed.

In step 708, merchant obtains a postal or email address from user 150 and any other form of information associated with user 150.

In step 710, merchant 140 processes payment information submitted by user 150 and a sale is completed.

In step 718, merchant 140 sends an email confirmation of purchase, or a confirmation via mail providing evidence of a purchase. Additionally, merchant 140 may also include any physical product and/or instructions for use of the product.

In step 720, data received from user 150 is used to update merchant databases 120A-N. In addition ancillary revenue maximization engine 130 and recommendation engine 160 may update databases associated with them as described earlier in the description.

In step 706, merchant 140 checks if user 150 has requested more information about the ancillary product or offer. If user 150 has not requested more information, the process ends. If a user has requested more information, step 712 is performed.

In step 712, merchant 140 provides additional information to user 150. As an example, such information may include, frequently asked questions related to a product, service or merchant 140 or any other merchant that may be offering the ancillary product.

In step 714, merchant 140 checks if user 150 needs additional information. If the user needs additional information, step 716 is performed. If user 150 does not need additional information, step 704 is performed.

In step 716, merchant 150 enables user 150 to converse with an online-agent or have a telephonic conversation with an agent. For example, an agent representing merchant 140 may be able to present other ancillary offers to user 150. Additionally an agent may update merchant databases 120A-N based on an outcome of such additional offers.

In this way, merchant 150 may present ancillary offers to user 150. Inputs from user and results of ancillary offers may be stored in databases associated with merchant 140, ancillary revenue maximization engine 130 and recommendation engine 160. Stored data from user 150 can then be used to alter business rules used by recommendation engine 160 to optimize offers as described earlier. Such a process may result in improved likelihood of acceptance of ancillary offers by user 150, leading to increased profit for merchant 140. In an embodiment, recommendation engine 160 can be placed at merchant 140 so that the logic is located within a merchants firewall. On a periodic basis, the business rules are updated from the ancillary revenue maximization engine 130 which is not co-located with the merchant 140.

### 5. Processing of Payment for Ancillary Product or Service

After user 150 has accepted an offer to purchase a ancillary product or service, merchant 140 processes payment offered by user 150.

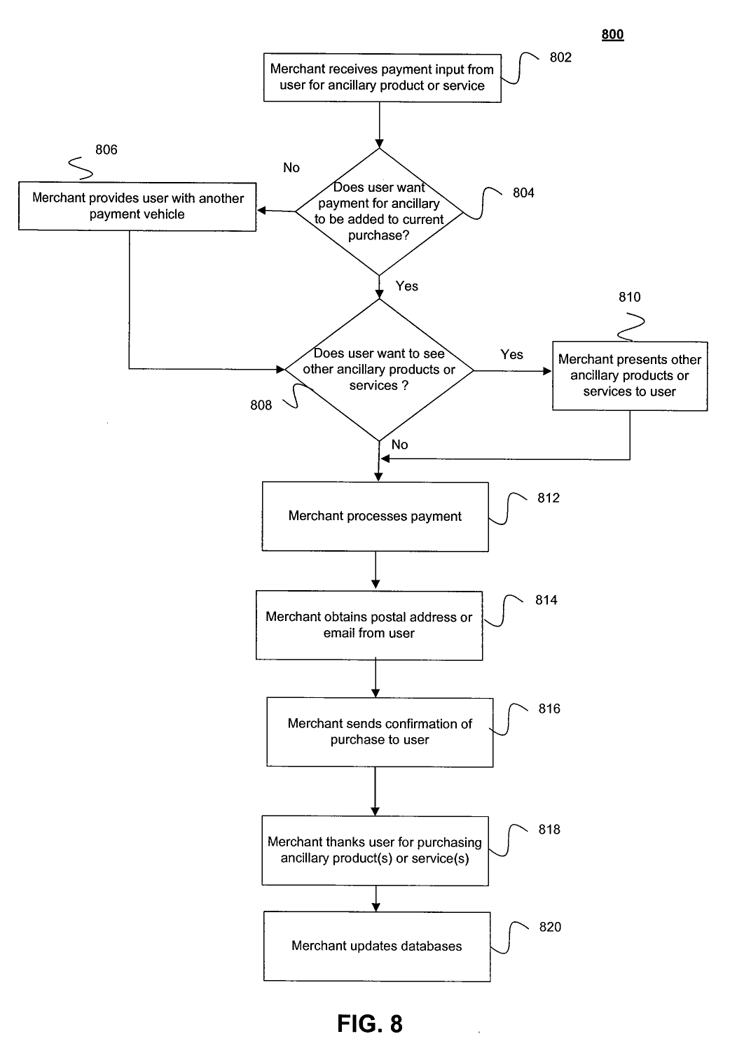

Exemplary processing of payment for a ancillary product or service between merchant 140 and user 150 will now be described in detail with reference to flowchart 800 in FIG. 8.

In step 802, merchant 140 receives input from user 150 related to payment for the ancillary.

In step 804, the merchant 140 checks if user 150 wants payment to be added to a product purchased earlier by user 150 during pre-sale user-merchant interaction. If a user wants payment to be added to a product purchased earlier by user 150, step 808 is performed. If a user does not want payment to be added to a product purchased earlier by user 150, step 806 is performed.

In step 806, merchant 140 provides user with another payment vehicle to process payment for the ancillary product or service to process payment and step 808 is performed.

In step 808, merchant 140 checks if user 150 wants to see other ancillary products or services. If the user wants to see other products or offers, step 810 is performed. If user does not want to see other products or offers, step 812 is performed.

In step 810, merchant 140 presents other ancillary products or offers to user 150. As an example, method 700 as illustrated in FIG. 7 may be used to process sale of ancillary products or offers.

In step 812, merchant 140 processes the user's payment.

In step 814, merchant 140 obtains a confirmation postal address or email from user 150. As an example, such an address may be used by merchant 140 to send a confirmation to user 150 indicating that the payment for the ancillary was processed successfully.

In step 816, merchant 140 sends an email confirmation of purchase, or a confirmation via mail providing evidence of a purchase. Additionally, merchant 140 may also include any physical product and/or instructions for use of the product.

In step 818, merchant 140 displays a thank you message to user 150 thanking the user for the purchase of a ancillary product or service. Additionally, merchant 140 may call or mail user 150 thanking user 150 for the purchase.

In step 820, merchant 140 updates merchant databases 120A-N and other databases that may be associated with ancillary revenue maximization engine 130 or recommendation engine 160.

In this way, merchant 140 may process payment for a ancillary product purchased by user 150.

### 6. Calculation of Commission to Ancillary Supplier

In certain cases, merchant 140 may offer user 150 a ancillary product or service that is being sold or marketed by a different merchant. In such a scenario, it may be necessary to provide the merchant who provides the ancillary with a commission based on an agreement between merchant 140 and the merchant who markets or supplies the ancillary. In an embodiment, the ancillary application is used as an ASP and is offered by another vendor who brings in additional products and services.

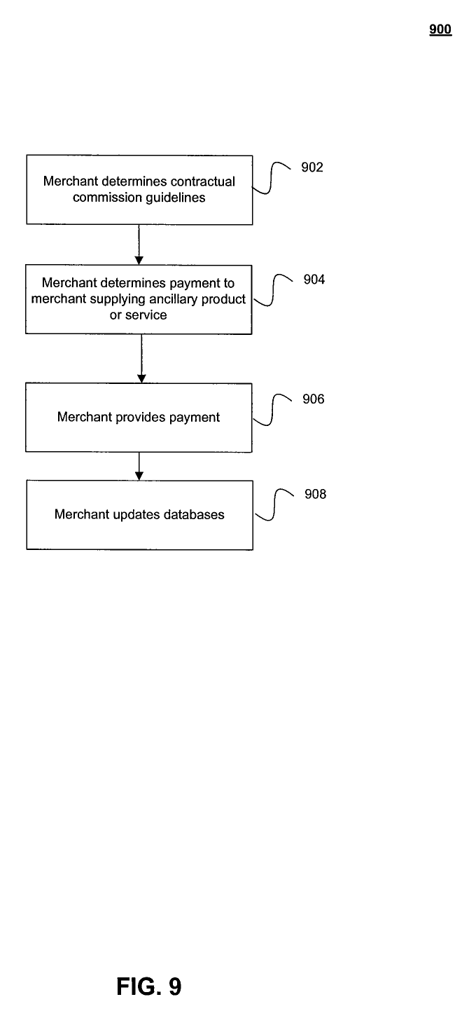

Exemplary calculation of commission will now be described in detail with reference to flowchart 900 in FIG. 9.

In step 902, merchant 140 determines contractual commission guidelines. Contractual commission guidelines may be determined by merchant 140 based on an initial agreement between merchant 140 and a merchant supplying the ancillary product or service. In an embodiment, such an agreement may be stored in an merchant database(s) 120A-N which may include product pricing and commission structure and a contract profile.

In step 904, merchant 140 determines payment to the merchant supplying the ancillary based on contractual commission guidelines that have been determined in step 902.

In step 906, merchant 140 provides payment to the merchant supplying the ancillary.

In step 908, merchant 140 updates merchant database(s) 120A-N. For example, merchant 140 may update merchant database(s) 120A-N with financial and contractual information.

In this way, merchant 140 determines and provides commission to another merchant who supplies a ancillary product or a service.

### 7. Example Computer Embodiment

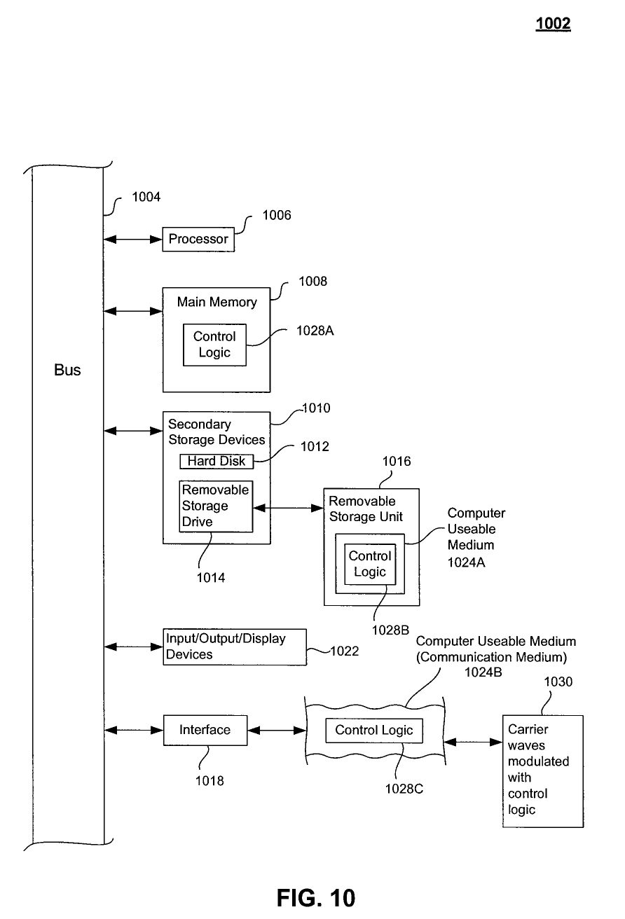

In an embodiment of the present invention, the system and components of embodiments described herein are implemented using well known computers, such as computer 1002 shown in FIG. 10. For example, ancillary revenue maximization engine 130 can be implemented using computer(s) 1002.

The computer 1002 can be any commercially available and well known computer capable of performing the functions described herein, such as computers available from International Business Machines, Apple, Sun, HP, Dell, Compaq, Digital, Cray, etc.

The computer 1002 includes one or more processors (also called central processing units, or CPUs), such as a processor 1006. The processor 1006 is connected to a communication bus 1004.

The computer 1002 also includes a main or primary memory 1008, such as random access memory (RAM). The primary memory 1008 has stored therein control logic 1028A (computer software), and data.

The computer 1002 also includes one or more secondary storage devices 1010. The secondary storage devices 1010 include, for example, a hard disk drive 1012 and/or a removable storage device or drive 1014, as well as other types of storage devices, such as memory cards and memory sticks. The removable storage drive 1014 represents a floppy disk drive, a magnetic tape drive, a compact disk drive, an optical storage device, tape backup, etc.

The removable storage drive 1014 interacts with a removable storage unit 1016. The removable storage unit 1016 includes a computer useable or readable storage medium 1024 having stored therein computer software 1028B (control logic) and/or data. Removable storage unit 1016 represents a floppy disk, magnetic tape, compact disk, DVD, optical storage disk, or any other computer data storage device. The removable storage drive 1014 reads from and/or writes to the removable storage unit 1016 in a well known manner.

The computer 1002 also includes input/output/display devices 1022, such as monitors, keyboards, pointing devices, etc.

The computer 1002 further includes a communication or network interface 1018. The network interface 1018 enables the computer 1002 to communicate with remote devices. For example, the network interface 1018 allows the computer 1002 to communicate over communication networks or mediums 1024B (representing a form of a computer useable or readable medium), such as LANs, WANs, the Internet, etc. The network interface 1018 may interface with remote sites or networks via wired or wireless connections.

Control logic 1028C may be transmitted to and from the computer 1002 via the communication medium 1024B. More particularly, the computer 1002 may receive and transmit carrier waves (electromagnetic signals) modulated with control logic 1030 via the communication medium 1024B.

Any apparatus or manufacture comprising a computer useable or readable medium having control logic (software) stored therein is referred to herein as a computer program product or program storage device. This includes, but is not limited to, the computer 1002, the main memory 1008, secondary storage devices 1010, the removable storage unit 1016 and the carrier waves modulated with control logic 1030. Such computer program products, having control logic stored therein that, when executed by one or more data processing devices, cause such data processing devices to operate as described herein, represent embodiments of the invention.

Embodiments of the invention may include a firewall, a router, a proxy server, an ecommerce server to provide the recommendations and prepare/process the offer requests on a real-time basis, a database of offers, a database to hold offer history, a data warehouse along with reporting tools, an ecommerce server to process purchases and payment including a system to route ancillary purchases to the appropriate merchant for final fulfillment and commission processing/verification.

The invention can work with software, hardware, and/or operating system implementations other than those described herein. Any software, hardware, and operating system implementations suitable for performing the functions described herein can be used.

### 8. Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way. It is also to be appreciated that while the present invention is described with respect to ancillary products and services, it may be applied to up-selling and the like.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method of generating a real-time ancillary offer, comprising:
obtaining information from a user;
generating an ancillary offer to sell an ancillary product or service using at least said information and input from a ancillary revenue maximization engine; and
providing said ancillary offer to said user.

2. The method of claim 1, wherein said information comprises information regarding a product purchased by a user.

3. The method of claim 1, wherein said generating step comprises:
obtaining a recommendation from a recommendation engine.

4. The method of claim 3, wherein said recommendation is based on at least a set of business rules.

5. The method of claim 4, wherein said business rules are altered based on said information.

6. The method of claim 3, wherein said recommendation is generated in real time.

7. The method of claim 3, wherein said ancillary offer is presented to said user based on said recommendation.

8. The method of claim 1, wherein said providing step comprises providing said ancillary offer based on said recommendation.

9. A method of generating a recommendation for an ancillary product or service, comprising:
obtaining data from an ancillary revenue maximization engine;
validating said data to generate validated data; and
selecting one or more rules based on said validated data;
wherein said rule is dynamically altered to optimize said recommendation.

10. The method of claim 8, wherein said recommendation is used by an ancillary revenue maximization engine to generate one or more offers for a ancillary product or service.

11. The method of claim 8, wherein said rules are dynamically altered using at least results of said offers presented to a user based on said recommendation.

12. The method of claim 8, further comprising:
classifying a user based on said data to obtain a user classification.

13. The method of claim 12, wherein said classification is used to optimize said recommendation.

14. The method of claim 12, further comprising:
identifying an ancillary product or service based on at least said classification.

15. The method of claim 12, further comprising:
selecting an offer medium for an ancillary offer based on at least said classification.

16. The method of claim 12, further comprising:
selecting an offer presentation format for an ancillary offer based on at least said classification.

17. The method of claim 8, further comprising:
identifying selection options to enable a user to select one or more ancillary products or services.

18. A system for generating an ancillary offer comprising:
a recommendation engine to generate a recommendation;
an ancillary revenue maximization engine to generate one or more offers based on said recommendation; and
means for providing said offers to a user.

19. The system of claim 18, further comprising one or more merchant databases.

20. The system of claim 18, wherein said recommendation engine obtains data from a single and multiple combination offer database, and a past offer outcomes and probability database.

21. The system of claim 20, wherein said single and multiple combination offer database obtains data from:
product ID database;
product premiums database;
product price database;
ancillary products database;
advertisement display media database;
packaging options database;
advertisement media content database; and
advertisement creatives database.

22. The system of claim 20, wherein said past offer outcomes and probability database obtains data from:
past product purchaser information database;
past purchase history database;
profitability history database;
external consumer database; and
positive and negative decision database.

23. The system of claim 18, wherein said recommendation engine generates said recommendation based on a set of business rules.

24. The system of claim 23, wherein said set of business rules are dynamically altered to optimize said offers.

25. The system of claim 24, wherein the product offer database further obtains data from:
available product database;
packaging and pricing database;
display media database;
advertisement content database;
product premium database; and
advertisement creatives database.

26. The system of claim 18, wherein said recommendation engine may access a external customer database and a product offer database.

27. A computer program product having control logic stored therein, said control logic enabling a processor to generate a real-time ancillary offer, said control logic comprising;
obtaining means for enabling a processor to obtain an input from a user;
generating means for enabling a processor to generate a recommendation for an ancillary product or service, based at least on said input; and
providing means for enabling a processor to provide said ancillary offer to said user based on said recommendation.
